(19) United States
(12) Patent Application Publication
(10) Pub. No.: US 2024/0369192 A1
(43) Pub. Date: Nov. 7, 2024

(54) UNDERGROUND NONMETALLIC PIPELINES USING HOLLOW CORE PHOTONIC BANDGAP FIBERS (HC-PBGFS) WITH FABRICATED MICROCHANNELS

(71) Applicant: SAUDI ARABIAN OIL COMPANY, Dhahran (SA)

(72) Inventors: Nada Alruwaii, Thuwal (SA); Ali Alshehri, Thuwal (SA)

(21) Appl. No.: 18/310,222

(22) Filed: May 1, 2023

(51) Int. Cl. F17D 5/06; F17D 5/00; G01M 3/38; G02B 6/02

(52) U.S. Cl. CPC F17D 5/06; F17D 5/005; G01M 3/38; G02B 6/02328

(57) ABSTRACT

A nonmetallic pipe for transporting fluid as part of an underground nonmetallic pipeline is provided. The nonmetallic pipe includes: a nonmetallic outer wall for burying underground and contacting the ground; a nonmetallic inner wall for containing and transporting the fluid as part of the nonmetallic pipeline; a rigid interior between the inner and outer walls for counteracting the fluid forces on the inner wall and the ground forces on the outer wall; hollow core photonic bandgap fibers (HC-PBGFs) embedded in the rigid interior for detecting leakage of the fluid through the nonmetallic pipe, each HC-PBGF including a plastic fiber surrounding a hollow core; and a microchannel fabricated in the plastic fiber of each HC-PBGF to expose the hollow core to an outside of the HC-PBGF.

### FIELD OF THE DISCLOSURE

The present disclosure relates generally to buried (or underground) nonmetallic pipelines, and specifically to underground nonmetallic pipelines that have added sensing functionality by using hollow core photonic bandgap fibers (HC-PBGFs) with fabricated microchannels.

### BACKGROUND OF THE DISCLOSURE

Using nonmetallic materials in underground pipelines effectively eliminates problems related to corrosion that can plague metal pipelines. However, nonmetallic pipelines are subject to other problems, such as leaks and deformations. Moreover, there is a lack of accurate monitoring methods for nonmetallic pipelines, such as for detecting leaks or deformations.

It is in regard to these and other problems in the art that the present disclosure is directed to provide a technical solution for an effective nonmetallic pipeline using HC-PBGFs with fabricated microchannels together with methods of fabricating and using such nonmetallic pipelines.

### SUMMARY OF THE DISCLOSURE

According to a first aspect of the disclosure, a nonmetallic pipe for transporting fluid as part of an underground nonmetallic pipeline is provided. The nonmetallic pipe comprises: a nonmetallic outer wall for burying underground and contacting the ground; a nonmetallic inner wall for containing and transporting the fluid as part of the nonmetallic pipeline; a rigid interior between the inner and outer walls for counteracting the fluid forces on the inner wall and the ground forces on the outer wall; hollow core photonic bandgap fibers (HC-PBGFs) embedded in the rigid interior for detecting leakage of the fluid through the nonmetallic pipe, each HC-PBGF including a plastic fiber surrounding a hollow core; and a microchannel fabricated in the plastic fiber of each HC-PBGF to expose the hollow core to an outside of the HC-PBGF.

In an embodiment consistent with the above, the rigid interior is nonmetallic.

In an embodiment consistent with the above, the fluid is a gas.

In an embodiment consistent with the above, for each HC-PBGF, the hollow core comprises a plurality of hollow cores and the fabricated microchannel exposes one of the hollow cores to the outside of the HC-PBGF.

In an embodiment consistent with the above, the fabricated microchannel is approximately 2 micrometers (μm) in width.

According to another aspect of the disclosure, a method of fabricating nonmetallic pipe for transporting fluid as part of an underground nonmetallic pipeline is provided. The method comprises: providing hollow core photonic bandgap fibers (HC-PBGFs) each including a plastic fiber surrounding a hollow core; fabricating a microchannel in the plastic fiber of each provided HC-PBGF to expose the hollow core to an outside of the HC-PBGF; embedding the fabricated HC-PBGFs in a rigid interior of a nonmetallic pipe of the nonmetallic pipeline; forming, on an inside of the rigid interior, a nonmetallic inner wall of the nonmetallic pipe for containing and transporting the fluid; and forming, on an outside of the rigid interior, a nonmetallic outer wall of the nonmetallic pipe for burying underground and contacting the ground, the rigid interior being between the formed inner and outer walls.

In an embodiment consistent with the method described above, fabricating the microchannel in the plastic fiber comprises using a laser to remove a microchannel-sized portion of the plastic fiber in order to expose the hollow core to the outside of the HC-PBGF.

In an embodiment consistent with the method described above, the laser is a Ti: sapphire laser.

In an embodiment consistent with the method described above, the microchannel-sized portion of the plastic fiber is approximately 2 micrometers (μm) in width.

In an embodiment consistent with the method described above, the rigid interior is nonmetallic.

In an embodiment consistent with the method described above, the fluid is a gas.

In an embodiment consistent with the method described above, for each HC-PBGF, the hollow core comprises a plurality of hollow cores and fabricating the microchannel comprises exposing one of the hollow cores to the outside of the HC-PBGF.

According to yet another aspect of the disclosure, a method of leak detection of a fluid from an underground nonmetallic pipeline for transporting the fluid is provided. The method comprises: transporting the fluid through a plurality of underground nonmetallic pipes of the nonmetallic pipeline, the nonmetallic pipes being connected in series and each comprising a nonmetallic outer wall, a nonmetallic inner wall, and a rigid interior between the inner and outer walls, the rigid interior comprising embedded hollow core photonic bandgap fibers (HC-PBGFs), each HC-PBGF including a plastic fiber surrounding a hollow core and a microchannel fabricated in the plastic fiber to expose the hollow core to an outside of the HC-PBGF; transmitting light along the hollow cores of the HC-PBGFs of each nonmetallic pipe from a transmitter; receiving the transmitted light at a receiver; comparing the received light with expected light using an electronic circuit; and alerting, by the electronic circuit, when the compared light differs from the expected light.

In an embodiment consistent with the method of leak detection described above, the method further comprises: comparing, using the electronic circuit, the received light with light indicative of the fluid being in the exposed hollow cores of the HC-PBGFs; and alerting, by the electronic circuit, of a fluid leak from the nonmetallic pipeline when the compared light is indicative of the fluid being in the exposed hollow cores.

In an embodiment consistent with the method of leak detection described above, the rigid interior is nonmetallic.

In an embodiment consistent with the method of leak detection described above, the fluid is a gas.

In an embodiment consistent with the method of leak detection described above, for each HC-PBGF, the hollow core comprises a plurality of hollow cores and the fabricated microchannel exposes one of the hollow cores to the outside of the HC-PBGF.

In an embodiment consistent with the method of leak detection described above, the fabricated microchannel is approximately 2 micrometers (μm) in width.

In an embodiment consistent with the method of leak detection described above, the method further comprises: transmitting second light through the plastic fiber of the HC-PBGFs of each nonmetallic pipe from a transmitter; receiving the transmitted second light at a receiver; comparing, using the electronic circuit, the received second light with expected second light; and alerting, by the electronic circuit, when the compared second light differs from the expected second light.

In an embodiment consistent with the method of leak detection described above, the method further comprises: comparing, using the electronic circuit, the received second light with light indicative of changes in strain or temperature of the nonmetallic pipeline; and alerting, by the electronic circuit, of a change in strain or temperature of the nonmetallic pipeline when the compared second light is indicative of the change.

Any combinations of the various embodiments and implementations disclosed herein can be used. These and other aspects and features can be appreciated from the following description of certain embodiments together with the accompanying drawings and claims.

### BRIEF DESCRIPTION OF THE DRAWINGS

FIG. 1A is a perspective view of an example nonmetallic pipe for transporting fluid as part of an underground nonmetallic pipeline, according to an embodiment.

FIG. 1B is a cross-sectional view of an example hollow core photonic bandgap fiber (HC-PBGF) with fabricated microchannel for the nonmetallic pipe of FIG. 1A, according to an embodiment.

FIGS. 2A-2D are cross-sectional views of example HC-PBGFs with fabricated microchannels, according to some embodiments.

FIG. 3 is a flow diagram of an example method of fabricating nonmetallic pipe for transporting fluid as part of an underground nonmetallic pipeline, according to an embodiment.

FIG. 4 is a flow diagram of an example method of leak detection of a fluid from an underground nonmetallic pipeline for transporting the fluid, according to an embodiment.

It is noted that the drawings are illustrative and not necessarily to scale, and that the same or similar features have the same or similar reference numerals throughout.

### DETAILED DESCRIPTION OF CERTAIN EMBODIMENTS OF THE DISCLOSURE

According to example embodiments, a method to create nonmetallic buried or underground pipelines through embedding Hollow Core Photonic Bandgap Fibers (HC-PBGFs) with fabricated microchannels in the pipe's structure is provided. This provides a reliable, safe, and accurate monitoring and inspection method for buried pipelines, especially nonmetallic pipelines. Here, “nonmetallic” refers to the materials used to make the exposed portions of the pipeline, such as the inner and outer walls, i.e., the portions susceptible to corrosion from exposure to the outside environment or to the fluid (gas or liquid) being transported by the pipeline. Portions of the pipelines shielded from corrosion (such as the interiors of the pipelines' walls) by the nonmetallic portions may be metallic, but such pipelines are still referred to as nonmetallic pipelines herein.

As discussed above, the integrity of underground pipelines can suffer over time from the effects of corrosion. In addition, damage to the pipelines can remain unnoticed until it significantly impacts the surrounding environment. Though nonmetallic pipelines help reduce or eliminate the effects of corrosion, leaks and deformations are still challenges to detect and address in a timely manner for such pipelines. In addition, nonmetallic pipelines can degrade in certain environments, are susceptible to mechanical damage, and their flexibility requires more support than with metallic pipelines. Further, there are relatively few monitoring methods of nonmetallic pipelines with the necessary precision to timely alert owners of leaks or deformations. Because of their difficult to access locations, underground pipelines for the oil and gas industry are particularly challenging. Furthermore, accurate inspection and maintenance traditionally requires excavating, which is a costly process. Nonmetallic pipelines benefit from accurate and continuous monitoring. However, there is a lack of cost effective, precise, and safe technologies for them.

Accordingly, in example embodiments, nonmetallic pipes used for underground pipelines have HC-PBGFs embedded in the pipes' structure. Here, the HC-PBGFs have fabricated microchannels in the fibers' peripheral (plastic) coatings to create microscopic openings that expose the substantially hollow cores of the HC-PBGFs. These openings allow fluid (particularly gases) leaking from the pipeline to enter the hollow cores of the HC-PBGFs. This causes light transmitted along the HC-PBGFs' hollow cores to change. Such changes can then be detected at a receiving end of the light, and the type of change can be used to assess the leak or deformation (e.g., location, type of fluid, and the like). These HC-PBGFs can function as solid plastic fibers and be used to monitor changes in strain and temperature by transmitting the light along the plastic fiber surrounding the hollow cores. Further, their hollow cores and the fabricated microchannels enable interactions between light and matter, enhancing gas leak detection.

Some embodiments provide for a method to detect gas leaks in nonmetallic buried pipelines. This, in combination with electronic circuits (such as processing circuits, lasers or light emitting diodes (LEDs), reflectometers, and spectrometers, to name a few), facilitates the creation of smart pipelines, which are programmed or otherwise configured to monitor themselves, detect deformations and leaks, and communicate their condition with inspection engineers continuously. In addition, in order to reduce catastrophic damage to pipeline corrosion, some embodiments use nonmetallic pipelines in place of metallic pipelines. This provides for a durable, effective alternative, and reduces or eliminates the possibility of corrosion. However, nonmetallic pipelines can have lower temperature and pressure limits than metallic pipelines.

In example embodiments, optical fibers offer methods to inspect and monitor pipelines. Optical fibers have several advantages in environmental and safety monitoring. Their thin flexible fibers and capabilities in long haul applications allow high levels of sensitivity and accuracy in sensing distributed parameters over hundreds of kilometers in length. They also facilitate using multiple arrays of sensors in fields. Optical fibers offer practical and reliable solutions to the problems encountered in pipeline monitoring. In some embodiments, optical fiber sensors are used to develop chemical and mechanical sensing systems with wide coverage and distributed sensing capabilities. However, there is limited research in the applications of optical fibers in the oil and gas industry.

In some embodiments, optical fibers are embedded in the pipeline structure for monitoring and sensing purposes, such as gas leaks. In comparable approaches, optical fibers only guide light through a solid core surrounded by cladding, which limits the direct interaction between the light in the fibers and the surrounding environment. Such approaches avoid direct contact between the light in the optical fibers and the environment, and instead rely on measuring mechanical surface changes, such as strain and pressure, caused by the environment on the cladding of the fibers. Such optical fiber strain sensors can detect corrasion and leakages, but are unlikely to detect them early enough to avoid at early stages, especially gas leaks. This is because the strain caused by the small particles of gas is very small and will not necessarily be measurable until the leak has significantly increased. Accordingly, in example embodiments, the optical fibers perform chemical sensing for accurate monitoring of gas leaks in the pipeline. In some such embodiments, the optical fibers help perform chemical sensing using Hollow Core Photonic Bandgap Optical Fibers (HC-PBGFs). These fibers are optical fibers with hollow cores, where light propagates in the hollow cores, making interactions between matter and light inside the fiber possible.

According to some embodiments, a method to create functional pipelines through embedding HC-PBGFs with microchannels within the pipeline's structure is provided. In some such embodiments, the HC-PBGFs (specifically, their hollow cores) are used for environmental chemical sensing, as light transmitted along the hollow cores will change characteristics in response to the chemicals (e.g., gases) being sensed. In some embodiments, the HC-PBGFs are used to monitor nonmetallic pipelines; these HC-PBGFs combine the features of regular fiber optics (using their plastic fibers) and chemical sensors (using their hollow cores).

In some embodiments, the HC-PBGFs use fabricated microchannels to enable more interaction between the propagated light and the surrounding environment. This provides for far greater accuracy of chemical sensing, especially gases. In some embodiments, the HC-PBGFs are embedded in the pipe's structure (such as the rigid interior of the pipe wall) from early manufacturing stages to create sensory “nerves.” In combination with processing circuits and other electronic equipment programmed or otherwise configured to carry out the chemical sensing tasks, these sensory nerves make the pipe functional in monitoring itself and communicating abnormalities to maintenance and inspection engineers.

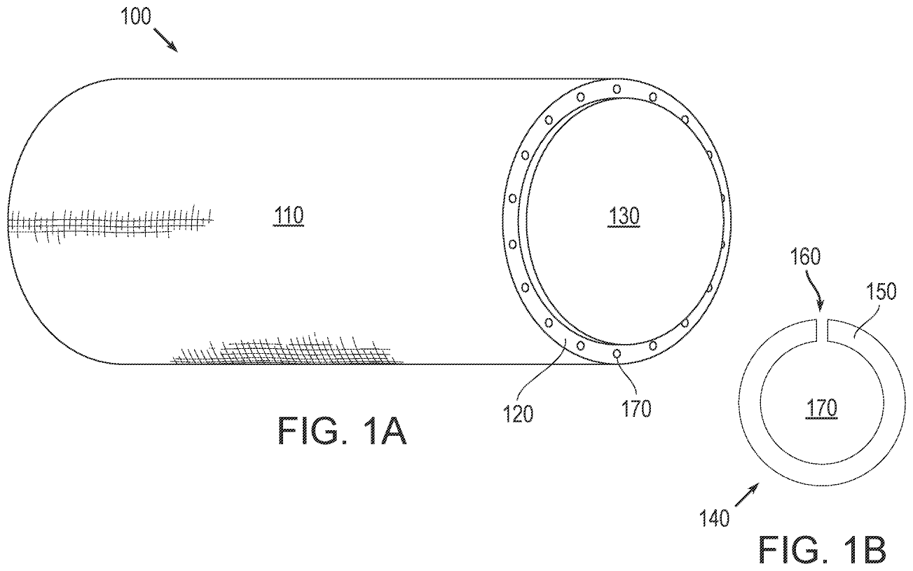

FIG. 1A is a perspective view of an example nonmetallic pipe 100 for transporting fluid (liquid or gas) as part of an underground nonmetallic pipeline, according to an embodiment. The nonmetallic pipe 100 includes a nonmetallic outer wall 110 for burying underground and contacting the ground, a nonmetallic inner wall 130 for containing and transporting the fluid as part of the nonmetallic pipeline, and a rigid interior 120 between the inner and outer walls for counteracting the fluid forces on the inner wall 130 and the ground forces on the outer wall 110. The nonmetallic pipe 100 further includes hollow core photonic bandgap fibers (HC-PBGFs) 140 embedded in the rigid interior 120 for detecting leakage of the fluid through the nonmetallic pipe 100.

FIG. 1B is a cross-sectional view of an example hollow core photonic bandgap fiber (HC-PBGF) 140 with fabricated microchannel 160 for the nonmetallic pipe 100 of FIG. 1A, according to an embodiment. The HC-PBGF 140 includes a plastic fiber 150 surrounding a hollow core 170. In addition, a microchannel 160 is fabricated (for example, laser etched) in the plastic fiber 150 to expose the hollow core 170 to an outside of the HC-PBGF 140. In some embodiments, the rigid interior 120 is also nonmetallic (as opposed to just the outer wall 110 and the inner wall 130. In some embodiments, the fluid is a gas. Gas leaks are significantly easier to detect by passing particular light wavelengths through the gas (e.g., in the hollow core 170 exposed by the microchannel 160) and measuring the light wavelengths on the other end after passing through the gas. In some embodiments, the hollow core 170 comprises a plurality of hollow cores 170 and the fabricated microchannel 160 exposes one of the hollow cores 170 to the outside of the HC-PBGF 140.

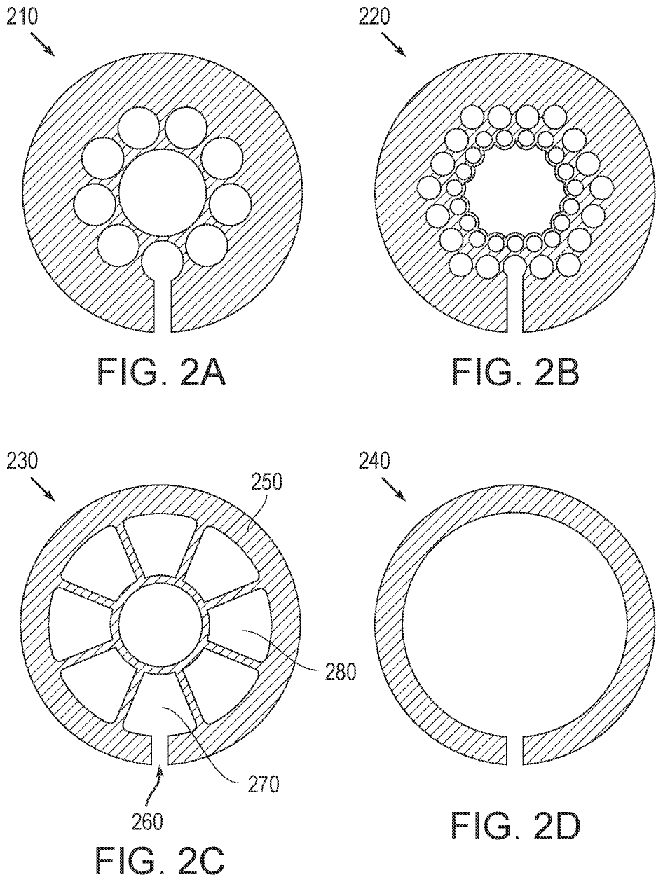

FIGS. 2A-2D are cross-sectional views of example HC-PBGFs 210, 220, 230, and 240 with fabricated microchannels 260, according to some embodiments. HC-PBGF 240 of FIG. 2D resembles HC-PBGF 140 of FIG. 1B (e.g., one hollow core 170). By contrast, HC-PBGFs 210, 220, and 230 introduce multiple hollow cores in a single HC-PBGF, one hollow core of which is exposed to an outside of the HC-PBGF by a fabricated microchannel. Using HC-PBGF 230 of FIG. 2C as an example, several hollow cores 280 (in a concentric pattern) are shown, including one exposed hollow core 270 that is exposed to an outside of the HC-PBGF 230 by fabricated microchannel 260.

In some embodiments, the HC-PBGFs are embedded in nonmetallic pipes as part of a chemical detection system used to monitor the status of a nonmetallic pipeline built with the pipes. To this end, FIGS. 2A-2D illustrate four possible configurations (or designs) of the one or more hollow cores 280 within the fiber. Each design enables a different light-matter interaction. For example, the design 210 of FIG. 2A has the microchannel aligned to one of the hollow cores forming an in-line sensing channel. Such a configuration increases the sensitivity to changes in refractive index (RI) inside the fiber's holes. The four example configurations 210, 220, 230, and 240 are representative of efficient fiber designs for HC-PBGFs for functionalizing nonmetallic pipes with advanced gas leak sensing capabilities. By way of example, in some embodiments, the microchannel fabrication is done using a femtosecond Ti: sapphire (titanium-sapphire) laser. Here, the laser output is focused onto the chosen locations of the fiber 250 to form the microchannels 260 with ˜2 μm (micrometer) widths and depths from the surface of the fiber 250 to the hollow core 270 being exposed.

In some embodiments, monitoring of the nonmetallic pipeline using the HC-PBGFs is continuous and provides accurate locations as multiple fibers are embedded along the entire length of the pipeline. The electronic circuitry is programmed or otherwise configured to provide information about a defect location along the pipeline using the transmitted light, in particular inferring the type of defect and location based on how the light transmitted differs from the light received. For example, in some embodiments, the electronic circuitry is programmed or otherwise configured to, when the received light differs from the transmitted light, provide information about the defect location, if the leak is a gas or a liquid, the identity of the leaked material, and its concentration, all from the changes in the transmitted lights. In some such embodiments, the electronic circuitry includes a microprocessor or other programmable circuit, and a combination of optical time domain reflectometers (OTDRs) and advanced spectrometers.

For example, OTDRs enable the microprocessor to be programmed to extract defect information from the transmitted and received light by noting the time of the wavelength's length, and then converting this time to a distance to estimate the location of the defect. In some embodiments, using the initial values of the sent wavelengths, and comparing them to the received values, the circuitry is programmed to use the spectrometer to identify the leaked material from the changed wavelengths. Each material absorbs light at different wavelengths. Accordingly, in some embodiments, by identifying the affected wavelength and the amount of the effect, the microprocessor is programmed to identify the leaked material and its concentration. In addition, by embedding multiple fibers within the pipeline's structure, the fibers continuously send information, enabling the creation of a comprehensive picture of the entire pipeline's condition.

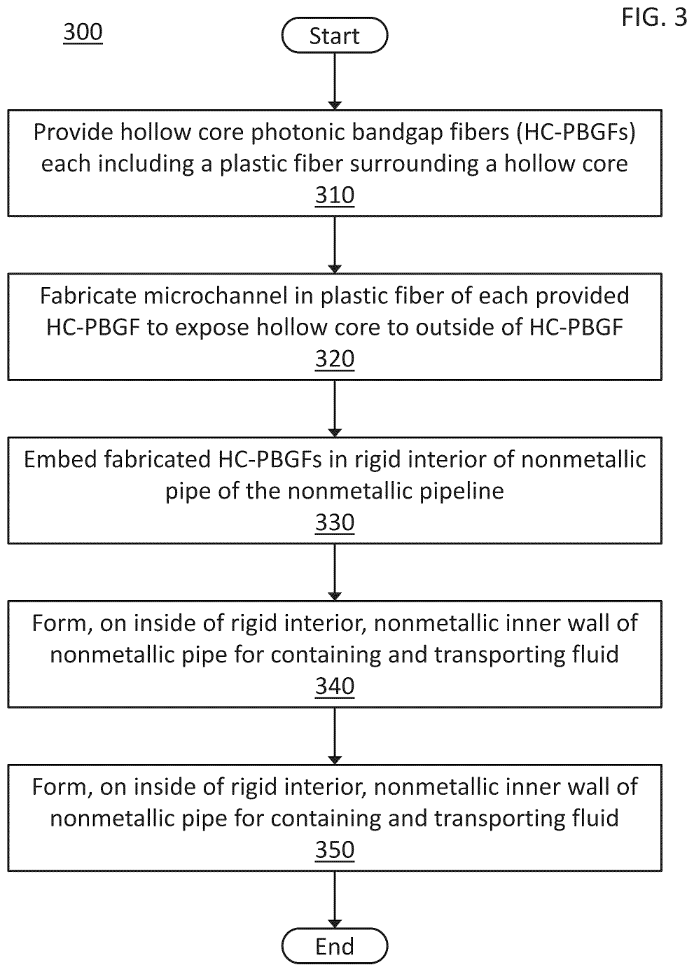

FIG. 3 is a flow diagram of an example method 300 of fabricating a nonmetallic pipe (such as nonmetallic pipe 100) for transporting fluid (such as a gas) as part of an underground nonmetallic pipeline, according to an embodiment. Portions of the method 300 (and other methods disclosed herein) can be automated under the control of one or more electronic circuits (such as processing circuits or microprocessors), which are configured (e.g., by code, such as programmed, by custom logic, as in configurable logic gates, or the like) to carry out some or all of the steps of the method 300.

Some or all of the method 300 (and other methods disclosed herein) can be performed using components and techniques illustrated in FIGS. 1A-2D. In addition, portions of this and other methods or processes disclosed herein can be performed on or using special logic, such as custom or preprogrammed control logic devices, circuits, or processors, as in a Programmable Logic Circuit (PLC), computer, software, or other circuit (e.g., ASIC, FPGA) configured by code or logic to carry out their assigned task. The devices, circuits, or processors can also be, for example, dedicated or shared hardware devices (such as laptops, single board computers (SBCs), workstations, tablets, smartphones, part of a server, or dedicated hardware circuits, as in FPGAs or ASICs, or the like), or computer servers, or a portion of a server or computer system. The devices, circuits, or processors can include a non-transitory computer readable medium (CRM, such as read-only memory (ROM), flash drive, or disk drive) storing instructions that, when executed on one or more processors, cause portions of the method 300 (or other disclosed method or process) to be carried out. It should be noted that in other embodiments, the order of the operations can be varied, and that some of the operations can be omitted. Some of the method 300 (and other methods disclosed herein) can also be performed using logic, circuits, or processors located on or in electrical communication with a processing circuit configured by code to carry out these portions of the method 300.

In the method 300, processing begins with the step of providing 310 hollow core photonic bandgap fibers (HC-PBGFs, such as HC-PBGF 140, 210, 220, 230, or 240) each including a plastic fiber (such as plastic fiber 150 or 250) surrounding a hollow core (such as hollow core 170 or exposed hollow core 270). The method 300 further includes the step of fabricating 320 a microchannel (such as microchannel 160 or 260) in the plastic fiber of each provided HC-PBGF to expose the hollow core to an outside of the HC-PBGF. In addition, the method 300 includes the step of embedding 330 the fabricated HC-PBGFs in a rigid interior (of a nonmetallic pipe of the nonmetallic pipeline. The method 300 also includes the step of forming 340, on an inside of the rigid interior, a nonmetallic inner wall (such as nonmetallic inner wall 130) of the nonmetallic pipe for containing and transporting the fluid. Further, the method 300 includes the step of forming 350, on an outside of the rigid interior, a nonmetallic outer wall (such as nonmetallic outer wall 110) of the nonmetallic pipe for burying underground and contacting the ground. Here, the rigid interior being between the formed inner and outer walls.

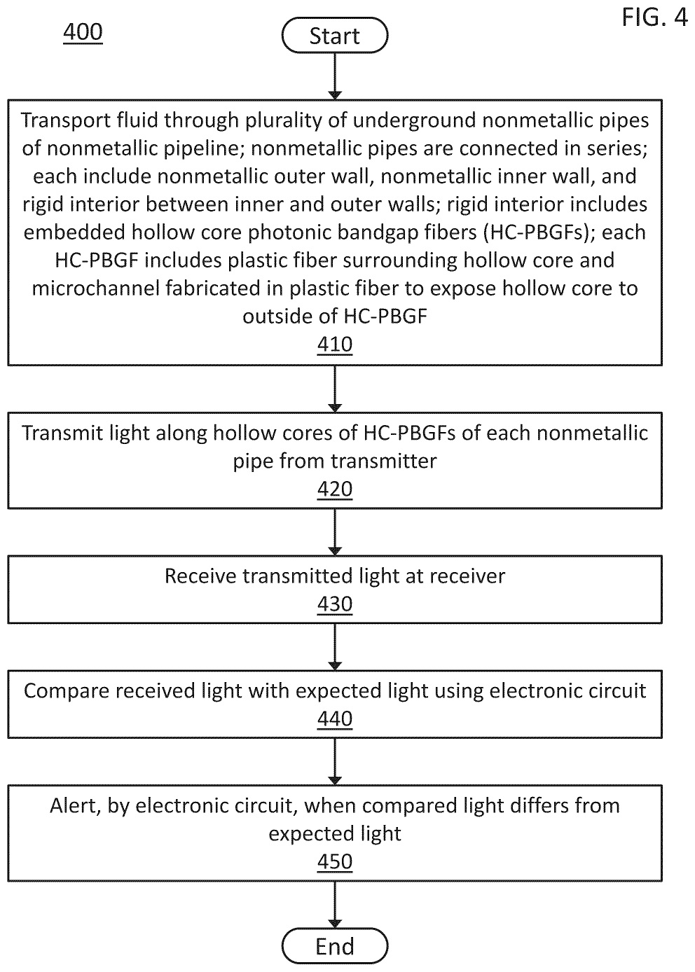

FIG. 4 is a flow diagram of an example method 400 of leak detection of a fluid from an underground nonmetallic pipeline for transporting the fluid, according to an embodiment. In the method 400, processing begins with the step of transporting 410 the fluid through a plurality of underground nonmetallic pipes of the nonmetallic pipeline. Here, the nonmetallic pipes are connected in series and each includes a nonmetallic outer wall, a nonmetallic inner wall, and a rigid interior between the inner and outer walls. The rigid interior includes embedded hollow core photonic bandgap fibers (HC-PBGFs). Each HC-PBGF includes a plastic fiber surrounding a hollow core and a microchannel fabricated in the plastic fiber to expose the hollow core to an outside of the HC-PBGF. The method 400 further includes the step of transmitting 420 light along the hollow cores of the HC-PBGFs of each nonmetallic pipe from a transmitter (such as a laser or LED). In addition, the method 400 includes the steps of receiving 430 the transmitted light at a receiver and comparing 440 the received light with expected light using an electronic circuit (such as a microprocessor). The method 400 also includes the step of alerting 450, by the electronic circuit, when the compared light differs from the expected light.

In accordance with example embodiments, the described technology has advantages over prior technologies, such as providing safe monitoring methods that are cost-effective, require minimal maintenance and human intervention, support sustainable manufacturing, enable advanced technologies such as creating smart pipes, eliminate excavating, and can be applied to a variety of assets such as gas pipelines. Some embodiments provide for a safe, accurate, and cost-effective solution for monitoring an underground nonmetallic pipeline's condition. In some embodiments, the embedded HC-PBGFs provide for self-sensing nonmetallic pipelines in the oil and gas industry. As such, the embedded HC-PBGFs function as sensory nerves in their corresponding nonmetallic pipeline, enabling the pipeline (in combination with electronic processing and instrumentation circuits) to monitor itself and communicate its condition to appropriate systems or personnel.

The methods described herein may be performed in part or in full by software or firmware in machine readable form on a tangible (e.g., non-transitory) storage medium. For example, the software or firmware may be in the form of a computer program including computer program code adapted to perform some or all of the steps of any of the methods described herein when the program is run on a computer or suitable hardware device (e.g., FPGA), and where the computer program may be embodied on a computer readable medium. Examples of tangible storage media include computer storage devices having computer-readable media such as disks, thumb drives, flash memory, and the like, and do not include propagated signals. Propagated signals may be present in a tangible storage media, but propagated signals by themselves are not examples of tangible storage media. The software can be suitable for execution on a parallel processor or a serial processor such that the method steps may be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing, and are not to be construed as limiting. However, it is recognized these terms could be used with reference to a viewer. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A nonmetallic pipe for transporting fluid as part of an underground nonmetallic pipeline, the nonmetallic pipe comprising:
a nonmetallic outer wall for burying underground and contacting the ground;
a nonmetallic inner wall for containing and transporting the fluid as part of the nonmetallic pipeline;
a rigid interior between the inner and outer walls for counteracting the fluid forces on the inner wall and the ground forces on the outer wall;
hollow core photonic bandgap fibers (HC-PBGFs) embedded in the rigid interior for detecting leakage of the fluid through the nonmetallic pipe, each HC-PBGF including a plastic fiber surrounding a hollow core; and
a microchannel fabricated in the plastic fiber of each HC-PBGF to expose the hollow core to an outside of the HC-PBGF.

2. The nonmetallic pipe of claim 1, wherein the rigid interior is nonmetallic.

3. The nonmetallic pipe of claim 1, wherein the fluid is a gas.

4. The nonmetallic pipe of claim 1, wherein for each HC-PBGF, the hollow core comprises a plurality of hollow cores and the fabricated microchannel exposes one of the hollow cores to the outside of the HC-PBGF.

5. The nonmetallic pipe of claim 1, wherein the fabricated microchannel is approximately 2 micrometers (μm) in width.

6. A method of fabricating nonmetallic pipe for transporting fluid as part of an underground nonmetallic pipeline, the method comprising:
providing hollow core photonic bandgap fibers (HC-PBGFs) each including a plastic fiber surrounding a hollow core;
fabricating a microchannel in the plastic fiber of each provided HC-PBGF to expose the hollow core to an outside of the HC-PBGF;
embedding the fabricated HC-PBGFs in a rigid interior of a nonmetallic pipe of the nonmetallic pipeline;
forming, on an inside of the rigid interior, a nonmetallic inner wall of the nonmetallic pipe for containing and transporting the fluid; and
forming, on an outside of the rigid interior, a nonmetallic outer wall of the nonmetallic pipe for burying underground and contacting the ground, the rigid interior being between the formed inner and outer walls.

7. The method of claim 6, wherein fabricating the microchannel in the plastic fiber comprises using a laser to remove a microchannel-sized portion of the plastic fiber in order to expose the hollow core to the outside of the HC-PBGF.

8. The method of claim 7, wherein the laser is a Ti: sapphire laser.

9. The method of claim 7, wherein the microchannel-sized portion of the plastic fiber is approximately 2 micrometers (μm) in width.

10. The method of claim 6, wherein the rigid interior is nonmetallic.

11. The method of claim 6, wherein the fluid is a gas.

12. The method of claim 6, wherein for each HC-PBGF, the hollow core comprises a plurality of hollow cores and fabricating the microchannel comprises exposing one of the hollow cores to the outside of the HC-PBGF.

13. A method of leak detection of a fluid from an underground nonmetallic pipeline for transporting the fluid, the method comprising:
transporting the fluid through a plurality of underground nonmetallic pipes of the nonmetallic pipeline, the nonmetallic pipes being connected in series and each comprising a nonmetallic outer wall, a nonmetallic inner wall, and a rigid interior between the inner and outer walls, the rigid interior comprising embedded hollow core photonic bandgap fibers (HC-PBGFs), each HC-PBGF including a plastic fiber surrounding a hollow core and a microchannel fabricated in the plastic fiber to expose the hollow core to an outside of the HC-PBGF;
transmitting light along the hollow cores of the HC-PBGFs of each nonmetallic pipe from a transmitter;
receiving the transmitted light at a receiver;
comparing the received light with expected light using an electronic circuit; and
alerting, by the electronic circuit, when the compared light differs from the expected light.

14. The method of claim 13, further comprising:
comparing, using the electronic circuit, the received light with light indicative of the fluid being in the exposed hollow cores of the HC-PBGFs; and
alerting, by the electronic circuit, of a fluid leak from the nonmetallic pipeline when the compared light is indicative of the fluid being in the exposed hollow cores.

15. The method of claim 13, wherein the rigid interior is nonmetallic.

16. The method of claim 13, wherein the fluid is a gas.

17. The method of claim 13, wherein for each HC-PBGF, the hollow core comprises a plurality of hollow cores and the fabricated microchannel exposes one of the hollow cores to the outside of the HC-PBGF.

18. The method of claim 13, wherein the fabricated microchannel is approximately 2 micrometers (μm) in width.

19. The method of claim 13, further comprising:
transmitting second light through the plastic fiber of the HC-PBGFs of each nonmetallic pipe from a transmitter;
receiving the transmitted second light at a receiver;
comparing, using the electronic circuit, the received second light with expected second light; and
alerting, by the electronic circuit, when the compared second light differs from the expected second light.

20. The method of claim 19, further comprising:
comparing, using the electronic circuit, the received second light with light indicative of changes in strain or temperature of the nonmetallic pipeline; and
alerting, by the electronic circuit, of a change in strain or temperature of the nonmetallic pipeline when the compared second light is indicative of the change.
